(19) United States
(12) Patent Application Publication
(10) Pub. No.: US 2024/0035279 A1
(43) Pub. Date: Feb. 1, 2024

(54) EXTRUSION PROFILE FOR MODULAR STRUCTURAL APPLICATIONS AND CORRESPONDING METHOD

(71) Applicant: Universite Laval, Quebec (CA)

(72) Inventors: Mario Fafard, Québec (CA); Amar Djedid, Québec (CA)

(21) Appl. No.: 18/285,748

(22) PCT Filed: Apr. 13, 2022
(86) PCT No.: PCT/CA2022/050571

§ 371 Date: Oct. 5, 2023

Related U.S. Application Data
(60) Provisional application No. 63/201,158, filed on Apr. 15, 2021.

(51) Int. Cl. E04C 3/08; B23K 20/12; B23K 20/233

(52) U.S. Cl. CPC E04C 3/08; B23K 20/122; B23K 20/129; B23K 20/2336; B23K 2101/28

(57) ABSTRACT

The present disclosure concerns an extrusion profile extending comprising: parallel and spaced-apart upper and lower panel members; and an inner core between the upper and lower panel members, the inner core being integral with and connecting the upper and lower panel members, the inner core comprising first and second curved connecting members having a concave side and the concave sides defining first and second concavities opened outwardly, each of the connecting members merging smoothly with each of the panel members in upper and lower panel-connecting portions of the inner core, the panel-connecting portions being offset inwardly with respect to the panel members to define assembling clearances in marginal edge regions of the upper and lower panel members. It also concerns a method for assembling a panel structure comprising a plurality of extrusion profiles and a corresponding modular structural assembly.

### PRIOR APPLICATION

The present application claims priority from U.S. provisional patent application No. 63/201,158, filed on Apr. 15, 2021, and entitled “HOLLOW-SHAPED EXTRUSION PROFILE FOR MODULAR STRUCTURAL APPLICATIONS AND CORRESPONDING METHOD”, the disclosure of which being hereby incorporated by reference in its entirety.

### TECHNICAL FIELD

The technical field relates to extrusion profiles, and more particularly to hollow-shaped extrusion profiles for modular structural applications and to corresponding methods.

### BACKGROUND

Extrusion profiles are used to form modular structural assemblies. The fatigue strength of the extrusion profile usually controls the design which must comply with multiple requirements such as, for instance, the requirements of the Canadian Highway Bridge Design Code (CHBDC), ASSHTO LRFD Bridge Design Specifications or Eurocode 9. There is need for optimised extrusion profile designs that exploit the fatigue strengths in both the plain (or base metal) and welded (or heat-affected zones HAZ) areas.

In view of the above, there is a need for an extrusion profile which would be able to overcome or at least minimize some of the above-discussed prior art concerns, and to corresponding modular structural assemblies and corresponding methods.

### BRIEF SUMMARY

It is therefore an aim of the present invention to address the above-mentioned issues.

According to a general aspect, there is provided an extrusion profile connectable to a similar extrusion profile, the extrusion profile extending along a longitudinal axis and comprising: upper and lower panel members extending longitudinally and substantially parallel to one another in a spaced-apart relationship along a height of the extrusion profile; and an inner core extending longitudinally between the upper and lower panel members, the inner core being integral with and connecting the upper and lower panel members, the inner core comprising first and second curved connecting members, each one having a concave side and the concave sides defining first and second concavities opened outwardly, each of the first and second curved connecting members merging smoothly with each of the upper and lower panel members in upper and lower panel-connecting portions of the inner core, the upper and lower panel-connecting portions being offset inwardly with respect to the upper and lower panel members to define assembling clearances in marginal edge regions of the upper and lower panel members.

According to another general aspect, there is provided an extrusion profile securable to a similar extrusion profile, the extrusion profile extending along a longitudinal axis and comprising: upper and lower panel members, each comprising an inner face and first and second longitudinal assembling end portions with the inner faces of the upper and lower panel members facing each other and being spaced-apart along a height of the extrusion profile; an inner core extending longitudinally between the inner faces of the upper and lower panel members and being integral therewith, the inner core comprising upper and lower panel-connecting portions connecting respectively with the inner faces of the upper and lower panel members; wherein the inner core and the first and second longitudinal assembling end portions of the upper and lower panel members define at least partially first and second concavities opened outwardly; wherein the upper panel-connecting portion is transversally offset inwardly with respect to the first and second longitudinal assembling end portions of the upper panel member to define therewith first and second upper assembling clearances; and wherein the lower panel-connecting portion is transversally offset inwardly with respect to the first and second longitudinal assembling end portions of the lower panel member to define therewith first and second lower assembling clearances.

According to another general aspect, there is provided a modular structural assembly, comprising at least one panel structure being at least partially formed by securing together a plurality of extrusion profiles according to the present disclosure.

According to another general aspect, there is provided a method for forming at least partially a modular panel structure, the method comprising: providing first and second extrusion profiles according to the present disclosure; positioning the first and second extrusion profiles in an adjacent configuration with the first longitudinal assembling end portions of the upper and lower panels of the first extrusion profile abutting respectively the second longitudinal assembling end portions of the upper and lower panels of the second extrusion profile; and securing together the abutting first and second longitudinal assembling end portions of the first and second extrusion profiles.

According to another general aspect, there is provided a hollow-shaped extrusion profile for modular structural applications, comprising: upper and lower panel members, each comprising an inner face and first and second assembling end portions with the inner faces of the upper and lower panel members being spaced-apart along a height of the extrusion profile; an inner core extending between the inner faces of the upper and lower panel members and being integral therewith, the inner core comprising upper and lower panel-connecting portions connecting respectively with the upper and lower panel members; wherein the inner core and the first and second assembling end portions of the upper and lower panel members define at least partially first and second concavities; wherein the upper panel-connecting portion is transversally offset inwardly with respect to the first and second assembling end portions of the upper panel member to define therewith first and second upper assembling clearances; and wherein the lower panel-connecting portion is transversally offset inwardly with respect to the first and second assembling end portions of the lower panel member to define therewith first and second lower assembling clearances.

According to another general aspect, there is provided a hollow-shaped extrusion profile connectable to a similar extrusion profile, comprising: upper and lower panel members extending longitudinally and substantially parallel to one another in a spaced-apart relationship along a height of the extrusion profile; and an inner core extending longitudinally, being integral with and connecting the upper and lower panel members, the inner core comprising two curved connecting members, each one having a concave side and a convex side, the convex sides of the curved connecting members facing each other and the concave sides defining two concavities opened outwardly, the curved connecting members merging smoothly with the upper and lower panel members in panel-connecting portions thereof, the panel-connecting portions being offset inwardly with respect to the upper and lower panel members to define assembling clearances in marginal edge regions of the upper and lower panel members.

According to another general aspect, there is provided a method for assembling a panel structure, the method comprising: providing a first and a second extrusion profiles according to the present disclosure; positioning the first and second extrusion profiles in an adjacent configuration with the first assembling end portions of the upper and lower panels of the first extrusion profile abut respectively the second assembling end portions of the upper and lower panels of the second extrusion profile; and securing together the abutting first and second assembling end portions of the first and second extrusion profiles.

### BRIEF DESCRIPTION OF THE DRAWINGS

FIG. 1 is a top perspective view of a modular structural assembly comprising a panel structure formed by a plurality of extrusion profiles in accordance with a first embodiment;

FIG. 2 is a cross-section view of one of the extrusion profiles of FIG. 1, the profile defining first and second concavities having substantially semi-circular cross-sections;

FIG. 2A is an enlarged view of an assembling clearance of the profile of FIG. 2;

FIG. 3 is a cross-section view of two extrusion profiles of FIG. 2 in an adjacent configuration and assembled together;

FIG. 4 is a top perspective view of a panel structure formed by assembling together a plurality of extrusion profiles of FIG. 2, a force being applied thereto;

FIG. 5 is a graphical representation of von Mises stresses undergone by the panel structure of FIG. 4 upon application of the force thereto;

FIG. 6 is a cross-section view of the graphical representation of FIG. 5;

FIG. 7 is a graphical representation of stresses undergone by the extrusion profiles of the panel structure of FIG. 4 in a direction perpendicular to assembling joints formed between adjacent extrusion profiles;

FIG. 8 is a cross-section view of the graphical representation of FIG. 7;

FIG. 9 is a cross-section view of an extrusion profile in accordance with another embodiment, the extrusion profile defining first and second concavities having substantially semi-elliptic cross-sections;

FIG. 10 is a top perspective view of a panel structure formed by assembling together a plurality of extrusion profiles of FIG. 9, a force being applied thereto;

FIG. 11 is a graphical representation of von Mises stresses undergone by the extrusion profiles of the panel structure of FIG. 10 upon application of the force thereto;

FIG. 12 is a cross-section view of the graphical representation of FIG. 11;

FIG. 13 is a graphical representation of stresses undergone by the extrusion profiles of the panel structure of FIG. 9 in a direction perpendicular to assembling joints formed between adjacent extrusion profiles; and

FIG. 14 is a cross-section view of the graphical representation of FIG. 13.

### DETAILED DESCRIPTION

In the following description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the extrusion profile and structural assemblies formed therewith and are not necessarily to scale.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not construed that there is only one of that element. It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

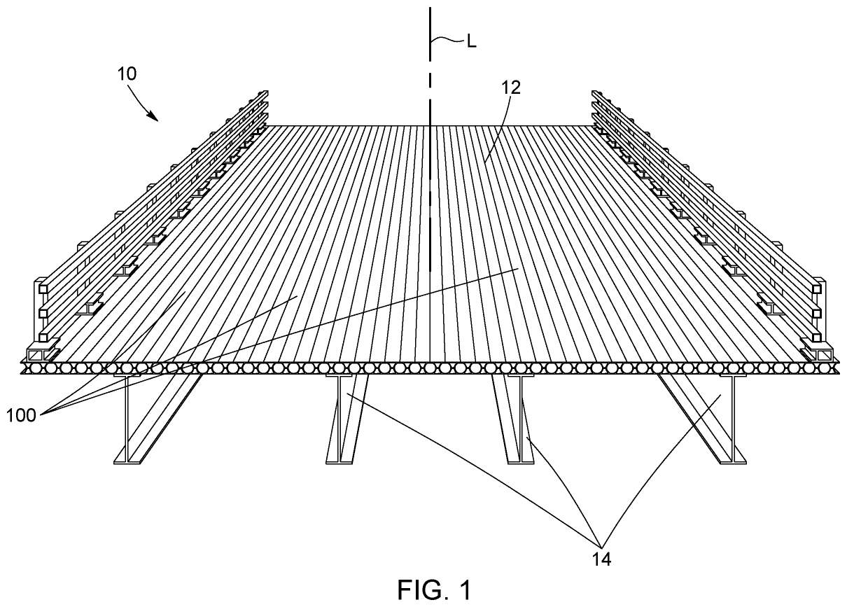

Referring now to the drawings, and more particularly to FIG. 1, there is shown a modular structural assembly 10 comprising a panel structure 12 extending along a longitudinal axis L and supported by a plurality of transversally spaced-apart panel-supporting beams 14, for instance at least partially made of steel and/or wood and/or any other material that can be used in the construction field. As detailed below, the panel structure 12 is formed by assembling (i.e., securing, i.e., connecting) together a plurality of hollow-shaped extrusion profiles 100 according to the present disclosure. As mentioned below, some of the plurality of the extrusion profiles could also be formed integral with each other, for instance via a single extrusion step. The hollow-shaped extrusion profiles 100 extend parallel to one another, along the longitudinal axis L, and are assembled at their longitudinal upper and lower edges, as will be described in more details below.

In the embodiment shown, the panel structure 12 of the modular structural assembly 10 is a deck, for instance to form at least partially a road bridge, for instance of several tens of meters of length and width with one or more vehicle-circulating traffic ways. The panel structure 12 could be used in different applications, such as, for instance, to form at least partially a boat deck, a trailer floor, a train floor, dump truck walls, a train roof or any other vehicle and the like.

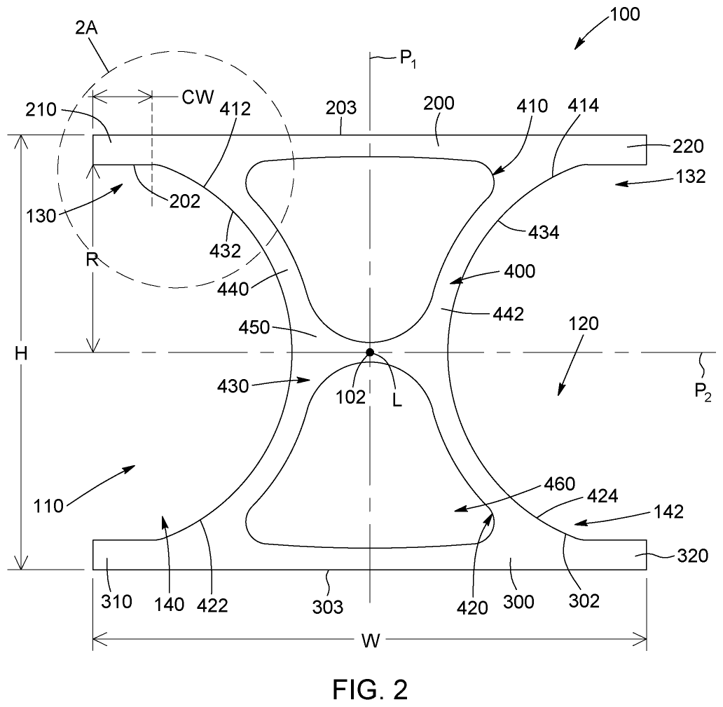

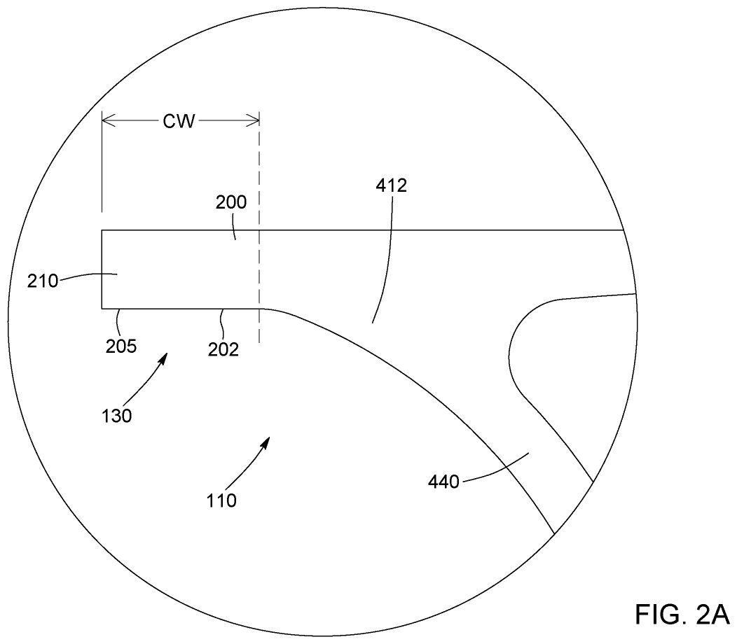

Now referring to FIGS. 2 to 8, there is shown a hollow-shaped extrusion profile 100 in accordance with a first embodiment. The extrusion profile 100 extends along the longitudinal axis L when a plurality of profiles 100 are assembled—or secured or connected—together to form the panel structure 12.

In the following description, unless otherwise stated, the terms inner, outer, inwardly, outwardly and the like should be understood with respect to an extrusion center 102 of the extrusion profile 100 (FIG. 2) and, in some implementations, with respect to an extrusion center axis extending substantially parallel to the longitudinal axis L of the extrusion profile 100.

Material

The extrusion profile 100 can be formed of any extrudable material, such as, for instance, metal-based materials (including alloys), concrete, polymeric materials, weldable material and the like. For instance, for metal-based materials, aluminum is increasingly used to replace aging concrete, steel or wood bridge decks. Typically, and as detailed below, aluminium decks are made from extrusion profiles welded together using for instance gas metal arc welding (GMAW) or friction-stir welding (FSW) techniques.

In the embodiment shown, the extrusion profile 100 might be made at least partially of an aluminum alloy, such as, for instance, AA6005A-T61. Aluminum, including aluminium alloys, is known to have strongness and resistance properties, to be easily welded, for instance by friction-stir welding methods, to be corrosion resistant without protective coatings, easily extruded, and to have high salvage value. Conventional extrusion techniques can produce required shapes of the extrusion profile to substantial lengths. The extrusion profile could be formed of any other weldable aluminum alloy or any other weldable material.

Even though the following description will mainly focus on a weldable extrusion profile, it should be understood that the present disclosure is not limited to extrusion profiles that would be at least partially formed of a weldable material.

Extrusion Profile

As best shown in FIG. 2, in the embodiment shown, the hollow-shaped extrusion profile 100 (for instance the hollow-shaped weldable extrusion profile 100) comprises upper and lower panel members 200, 300 (or upper and lower profile plates 200, 300) spaced-apart from each other along a height H of the profile 100. The height H, as represented in FIG. 2, should be understood in a cross-section transversal to the longitudinal axis L, for instance substantially perpendicular to the longitudinal axis L. Each one of the upper and lower profile plates 200, 300 comprises an inner face 202, 302, a substantially planar outer face 203, 303, and first and second upper and lower assembling end portions 210, 220, 310, 320 (or first and second upper and lower welding end portions 210, 220, 310, 320, when the extrusion profile is at least partially weldable). In the embodiment shown, the upper and lower panel members 200, 300 extend substantially parallel to one another along the longitudinal axis L and are spaced-apart from each other along the height H of the profile 100. The inner faces of the upper and lower panel members face each other.

Inner Core

The extrusion profile 100 further comprises an inner core 400 or inner web 400 extending between the inner faces 202, 302 of the upper and lower panel members 200, 300, connecting the upper and lower panel members 200, 300 together, and being integral therewith (integral with the inner faces of the upper and lower panel members). In the embodiment shown, the inner core 400 comprises upper and lower panel-connecting portions 410, 420, the inner core 400 being connected to the upper and lower panel members 200, 300 (to the inner faces thereof) via respectively the upper and lower panel-connecting portions 410, 420.

The inner core 400 further comprises a core body 430—or web body 430—arranged between the upper and lower panel-connecting portions 410, 420 and being integral therewith. In the following description, the term “hollow-shaped” relative to the extrusion profile refers to extrusion profiles having a substantially hollow-shaped inner core (or substantially hollow-shaped core body). However, the disclosure is not limited to hollow shaped extrusion profiles, and it could be conceived extrusion profiles with a substantially filled inner core.

In the embodiment shown, the core body 430 is substantially hollow and comprises first and second substantially curved connecting members 440, 442 (or substantially C-shaped connecting members with one of them being inverted or curved panel-connecting members), each of the first and second curved connecting members extending between the inner faces 202, 302 of the upper and lower panel members 200, 300 and at least partially delimiting therebetween a core cavity 460. The core body 430 also comprises an inner bridge portion 450 located in the core cavity 460 and extending between the first and second connecting members 440, 442 and being integral therewith. In the non-limitative embodiment shown, the inner bridge portion 450 comprises the extrusion center 102. In the embodiment shown, the core cavity 460 is thus divided into lower and upper parts separated from each other by the inner bridge portion 450. In the embodiment shown, a cross-section of the core body (considered in a plan transversal to the longitudinal axis L) is substantially a curved X-shaped profile (or a substantially curved H-shaped profile). Alternatively, the core body 430 could be defined as two C-shaped connecting members 440, 442 with one of them being inverted, the connecting members 440, 442 being connected together by the inner bridge portion 450 at their convex side in a middle thereof along the profile height H. It could also be conceived a core body that would have any other shape between the concave sides of the first and second curved connecting members; it could for instance be conceived an inner core which would comprise one or more additional curved members extending longitudinally between the first and second curved connecting members (for instance between the convex sides of the first and second curved connecting members).

The core body 430 merges smoothly with the upper and lower panel members 200, 300 (with the inner faces thereof) at the first and second assembling—or welding—end portions 210, 220, 310, 320 with the first and second connecting members 440, 442 being widen slightly at the first and second assembling—or welding—end portions 210, 220, 310, 320 to be free of sharp edges.

In other words, the inner core 400 comprises two curved connecting members, each one having a concave side and an opposed convex side, the convex sides of the curved connecting members facing each other and being spaced apart from each other by the inner bridge portion, in the embodiment shown. In the embodiment shown, the core cavity 460 is at least partially delimited by the opposed convex sides of the first and second curved connecting members. In the embodiment shown, the inner bridge portion 450 extends between the opposed convex sides of the first and second curved connecting members and is integral therewith. The concave sides of the two curved connecting members define two concavities opened outwardly. The curved connecting members merge smoothly with the upper and lower panel members in panel-connecting portions thereof.

It could also be conceived a core body that would be substantially filled (i.e., with no core cavity therein) or a core body having any other shape.

First and Second Cavities

In the embodiment shown, the inner core 400 and the first and second assembling (or welding) end portions 210, 220, 310, 320 of the upper and lower panel members 200, 300 define at least partially first and second concavities 110, 120, extending longitudinally along the longitudinal axis L and located on opposed transversal sides of the extrusion profile 100. In the embodiment shown, the first and second concavities 110, 120 are at least partially delimited by first and second opposed outer faces 432, 434 of the core body 430 (of the first and second connecting members 440, 442 thereof, in the embodiment shown at their concave side), the upper and lower panel-connecting portions 410, 420 and the first and second assembling—or welding—end portions 210, 220, 310, 320 (i.e., the inner faces of the upper and lower panel members forming at least partially the upper and lower first and second assembling end portions).

In other words, at an upper part thereof, the first concavity 110 is at least partially delimited by the first outer face 432 of the core body 430 (i.e., a first concave side thereof), the first upper assembling—or welding—end portion 210 (the inner face thereof) and a first upper junction 412 between the first upper welding end portion 210 and the first outer face 432 of the core body 430, said first upper junction 412 being at least partially formed by the upper panel-connecting portion 410. At a lower part thereof, the first concavity 110 is at least partially delimited by the first outer face 432 of the core body 430 (i.e., the first concave side thereof), the first lower assembling—or welding—end portion 310 (the inner face thereof) and a first lower junction 422 between the first lower welding end portion 310 and the first outer face of the core body 430, said first lower junction 422 being at least partially formed by the lower panel-connecting portion 420.

Similarly, at an upper part thereof, the second concavity 120 is at least partially delimited by a second outer face 434 of the core body 430 (i.e., a second concave side thereof), the second upper welding end portion 220 (the inner face thereof) and a second upper junction 414 between the second upper welding end portion 220 and the second outer face of the core body 430, said second upper junction 414 being at least partially formed by the upper panel-connecting portion 410. At a lower part thereof, the second concavity 120 is at least partially delimited by the second outer face 434 of the core body 430 (i.e., the second concave side thereof), the second lower welding end portion 320 (the inner face thereof) and a second lower junction 424 between the second lower welding end portion 320 and the second outer face of the core body 430, said second lower junction 424 being at least partially formed by the lower panel-connecting portion 420.

In the embodiment shown, as represented in FIG. 2, the extrusion profile 100 comprises a first plane of symmetry P1 substantially perpendicular to the upper and lower panel members 200, 300 and substantially parallel to the longitudinal axis L. The extrusion profile 100 further comprises a second plane of symmetry P2 substantially perpendicular to the first plane of symmetry P1 (i.e., substantially parallel to the upper and lower panel members 200, 300 in the embodiment shown) and substantially parallel to the longitudinal axis L). In the embodiment shown, the first and second planes of symmetry P1, P2 intersect at the center 102 of the extrusion profile 100. The intersection of the first and second planes of symmetry P1, P2 is substantially parallel to the longitudinal axis L. The first and second planes of symmetry P1, P2 are substantially perpendicular to each other.

Assembling Clearances

In the embodiment shown, the upper panel-connecting portion 410 (or at least the first upper junction 412 and the second upper junction 414 thereof) is transversally offset inwardly with respect to the first and second upper assembling—or welding—end portions 210, 220 of the upper panel member 200 to define therewith first and second upper assembling clearances 130, 132 (or first and second upper welding clearances 130, 132 when the extrusion profile 100 is at least partially weldable and comprises first and second upper welding end portions 210, 220). In other words, the first and second upper assembling clearances 130, 132 define at least partially upper parts of the first and second concavities 110, 120. In other words, the assembling clearances are defined by the upper panel-connecting portion in marginal edge regions of the upper panel member.

In the embodiment shown, the lower panel-connecting portion 420 (or at least the first lower junction 422 and the second lower junction 424) is transversally offset inwardly with respect to the first and second lower assembling—or welding—end portions 310, 320 of the lower panel member 300 to define therewith first and second lower assembling—or welding—clearances 140, 142. In other words, the first and second lower assembling clearances 140,142 define at least partially lower parts of the first and second concavities 110, 120. In other words, the assembling clearances are defined by the lower panel-connecting portion in marginal edge regions of the lower panel member.

In other words, the first concavity 110 is at least partially formed by the upper and lower first assembling—or welding—clearances 130, 140. The second concavity 120 is at least partially formed by the upper and lower second assembling—or welding—clearances 132, 142.

In the embodiment shown and without being limitative, the first and second concavities 110, 120 both have a substantially semi-circular cross-section.

Dimensions

As detailed below, in the embodiment wherein the extrusion profile 100 is at least partially formed of a weldable material, the first and second lower and upper welding clearances 130, 132, 140, 142 might be shaped and dimensioned to enable the use of a bobbin tool for a welding of the welding end portions of the upper and lower panel members of adjacent extrusion profiles via FSW—friction-stir welding (for instance bobbin tool friction stir welding—BTFSW).

As best shown in FIG. 2, considered in a plane substantially perpendicular to the longitudinal axis L, the extrusion profile 100 has the height H defined between the outer faces 203, 303 of the upper and lower panel members 200, 300. The extrusion profile 100 has a width W defined between outer edges of the first and second upper welding end portions 210, 220 (or between outer edges of the first and second lower welding end portions 310, 320, due to the above-mentioned second plane of symmetry P2).

In the embodiment shown, the width W is equal to or greater than the height H. In some embodiments, the width W is greater than about 110% of the height H. In some other embodiments, the width W is greater than about 120% of the height H. In yet some other embodiments, the width W is greater than about 130% of the height H.

In some embodiments, the height H is comprised between about 5 mm and 800 mm. In some other embodiments, the height H is comprised between about 10 mm and 600 mm. In some other embodiments, the height H is comprised between about 20 mm and 500 mm. In some other embodiments, the height H is comprised between about 25 mm and 250 mm. In some other embodiments, the height H is comprised between about 50 mm and 200 mm. In some other embodiments, the height H is comprised between about 100 mm and 150 mm. In yet some other embodiments, the height H is comprised between about 115 mm and 135 mm.

In some embodiments, the width W is comprised between about 25 mm and 500 mm. In some other embodiments, the width W is comprised between about 50 mm and 250 mm. In some other embodiments, the width W is comprised between about 100 mm and 220 mm. In some other embodiments, the width W is comprised between about 125 mm and 200 mm. In yet some other embodiments, the width W is comprised between about 145 mm and 175 mm.

In the embodiment shown wherein the first and second concavities 110, 120 both have a substantially semi-circular cross-section, a radius R of the first and second concavities corresponds substantially to a half of the height H (minus at least a portion of a thickness of the upper and lower panel members 200, 300, for instance minus substantially a half of the thickness of one of the upper and lower panel members 200, 300).

In the embodiment shown, the width W is greater than the radius R. In some other embodiments, the width W is greater than about 200% of the radius R. In some other embodiments, the width W is greater than about 250% of the radius R. In yet some other embodiments, the width W is greater than about 300% of the radius R.

As represented in FIG. 2, the welding clearances 130, 132, 140, 142 have a clearance width CW. In the embodiment shown and without being limitative, the clearance widths of the different welding clearances are substantially identical, due to the above-mentioned first and second planes of symmetry. In the embodiment shown, the clearance width CW is greater than at least 5% of the radius R. In some embodiments, the clearance width CW is greater than at least 10% of the radius R. In some embodiments, the clearance width CW is greater than at least 20% of the radius R. In yet some embodiments, the clearance width CW is greater than at least 30% of the radius R.

As best shown in FIG. 2A, the inner face 202 of the upper panel member 200 (for instance the inner face of the welding—or assembling—end portion 210 thereof) delimiting at least partially the welding clearance 130 is substantially flat or planar (i.e., defines a substantially planar portion 205), at least along a portion of the clearance width CW thereof.

In the embodiment shown, the inner face 202 of the upper panel member 200 is substantially planar along substantially an entirety of the clearance width CW of the corresponding welding clearance 130. For instance, the substantially planar portion 205 has a width (corresponding to the clearance width CW in the embodiment shown) greater than about 5% of the width W of the extrusion profile 100. In some other embodiments, the width of the substantially planar portion 205 is greater than about 7% of the width W of the extrusion profile 100. In some other embodiments, the width of the substantially planar portion 205 is greater than about 10% of the width W of the extrusion profile 100. In some other embodiments, the width of the substantially planar portion 205 is greater than about 12% of the width W of the extrusion profile 100.

In some embodiments, the width of the substantially planar portion 205 (corresponding to the clearance width CW in the embodiment shown) is greater than about 5 mm. In some other embodiments, the width of the substantially planar portion 205 is greater than about 10 mm. In some other embodiments, the width of the substantially planar portion 205 is greater than about 12 mm. In some other embodiments, the width of the substantially planar portion 205 is greater than about 15 mm. In yet some other embodiments, the width of the substantially planar portion 205 is greater than about 18 mm. The profile of the inner face of the upper and lower panels delimiting at least partially the welding clearances is not limited to the shown embodiment.

For instance, the clearance width CW is comprised between about 5 mm and about 50 mm. In some embodiments, the clearance width CW is comprised between about 10 mm and about 45 mm. In some embodiments, the clearance width CW is comprised between about 20 mm and about 30 mm.

It is appreciated that the shape of the extrusion profile can vary from the embodiment shown.

### Other Possible Embodiment

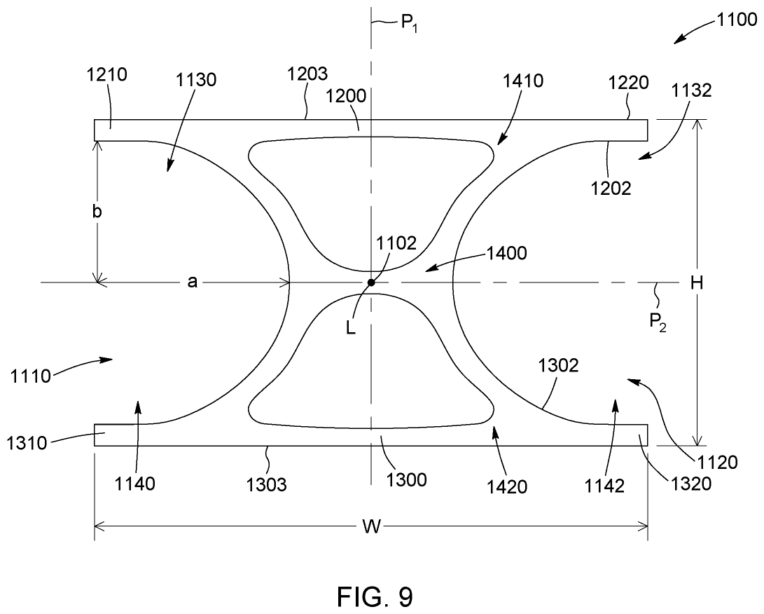

FIG. 9 represents a second possible embodiment of the extrusion profile 1100.

Similar to the first embodiment, the hollow-shaped extrusion profile 1100 comprises upper and lower panel members 1200, 1300 spaced-apart from each other along the height H and each comprising an inner face 1202, 1302 and first and second assembling end portions 1210, 1220, 1310, 1320. The extrusion profile 1100 also comprises an inner core 1400 extending between the inner faces of the upper and lower panel members 1200, 1300 and being integral therewith, the inner core comprising upper and lower panel-connecting portions 1410, 1420. The inner core 1400 and the first and second longitudinal assembling end portions 1210, 1220, 1310, 1320 of the upper and lower panel members 1200, 1300 define at least partially first and second concavities 1110, 1120, extending longitudinally along the longitudinal axis L and located on opposed transversal sides of the extrusion profile 1100. The upper panel-connecting portion 1410 is transversally offset inwardly with respect to the first and second assembling end portions 1210, 1220 of the upper panel member 1200 to define therewith first and second upper assembling clearances 1130, 1132; the lower panel-connecting portion 1420 is transversally offset inwardly with respect to the first and second assembling end portions 1310, 1320 of the lower panel member 1300 to define therewith first and second lower assembling clearances 1140, 1142.

Similar to the first embodiment, the extrusion profile 1100 comprises a first plane of symmetry P1 substantially perpendicular to the upper and lower panel members 1200, 1300 and substantially parallel to the longitudinal axis L. The extrusion profile 1100 further comprises a second plane of symmetry P2 substantially perpendicular to the first plane of symmetry P1 (i.e., substantially parallel to the upper and lower panel members 1200, 1300 in the embodiment shown) and substantially parallel to the longitudinal axis L). In the embodiment shown, the first and second planes of symmetry P1, P2 intersect at a center 1102 of the extrusion profile 1100.

The intersection of the first and second planes of symmetry P1, P2 is substantially parallel to the longitudinal axis L.

The present disclosure is not limited to first and second concavities having a substantially semi-circular cross-section. In the embodiment shown, the first and second concavities 1110, 1120 each have a substantially semi-oval (or semi-elliptic) cross-section. In the embodiment shown, the first and second concavities have a similar cross-section but it could be conceived an extrusion profile with different concavities.

As best shown in FIG. 9, the first concavity 1110 has a semi-major axis a and a semi-minor axis b, the semi-major axis a being greater than the semi-minor axis b. For instance, the semi-major axis a is greater than about 105% of the semi-minor axis b. In some embodiments, the semi-major axis a is greater than about 110% of the semi-minor axis b. In some embodiments, the semi-major axis a is greater than about 115% of the semi-minor axis b. In some embodiments, the semi-major axis a is greater than about 120% of the semi-minor axis b. In yet some embodiments, the semi-major axis a is greater than about 125% of the semi-minor axis b.

For instance, an eccentricity of the semi-elliptic cross-section of the first and second concavities 1110, 1120 is comprised between about 0.1 and about 0.9. In some other embodiments, the eccentricity of the semi-elliptic cross-section of the first and second concavities 1110, 1120 is comprised between about 0.2 and about 0.8. In some other embodiments, the eccentricity of the semi-elliptic cross-section of the first and second concavities 1110, 1120 is comprised between about 0.4 and about 0.7.

As best shown in FIG. 9, considered in a plane substantially perpendicular to the direction L, the height H is defined between outer faces 1203, 1303 of the upper and lower panel members 1200, 1300. The extrusion profile 1100 has a width W defined between the first and second upper welding end portions 1210, 1220 (or between the first and second lower welding end portions 1310, 1320, due to the above-mentioned second plane of symmetry P2).

In the embodiment shown, the width W is greater than the height H. In some embodiments, the width W is greater than about 120% of the height H. In some other embodiments, the width W is greater than about 140% of the height H. In some other embodiments, the width W is greater than about 160% of the height H. In yet some other embodiments, the width W is greater than about 170% of the height H.

In some embodiments, the height H is comprised between about 25 mm and 225 mm. In some other embodiments, the height H is comprised between about 50 mm and 150 mm. In some other embodiments, the height H is comprised between about 75 mm and 125 mm. In yet some other embodiments, the height H is comprised between about 90 mm and 100 mm.

In some embodiments, the width W is comprised between about 25 mm and 300 mm. In some other embodiments, the width W is comprised between about 50 mm and 250 mm. In some other embodiments, the width W is comprised between about 100 mm and 220 mm. In some other embodiments, the width W is comprised between about 125 mm and 200 mm. In yet some other embodiments, the width W is comprised between about 145 mm and 175 mm.

In the embodiment shown, the semi-minor axis b corresponds substantially to a half of the height H, minus a portion of a thickness of the upper and lower panel members (for instance minus substantially a half of the thickness of one of the upper and lower panel members). In the embodiment shown, the semi-major axis a is greater than a half of the height H. In the embodiment shown, the semi-minor axis b is substantially perpendicular to the plane of the upper and lower panel members.

In the embodiment shown, the width W is greater than the semi-minor axis b. In some embodiments, the width W is greater than about 200% of the semi-minor axis b. In some other embodiments, the width W is greater than about 250% of the semi-minor axis b. In some other embodiments, the width W is greater than about 300% of the semi-minor axis b. In some other embodiments, the width W is greater than about 350% of the semi-minor axis b. In yet some other embodiments, the width W is greater than about 380% of the semi-minor axis b. In the embodiment shown, the width W is greater than the semi-major axis a. In some other embodiments, the width W is greater than about 200% of the semi-major axis a. In some other embodiments, the width W is greater than about 250% of the semi-major axis a. In yet some other embodiments, the width W is greater than about 300% of the semi-major axis a.

For instance, the first and second embodiments of the extrusion profiles 100, 1100 have substantially similar widths. For instance, the height of the extrusion profile 1100 in accordance with the second embodiment is smaller than the height of the extrusion profile 100 in accordance with the first embodiment. For instance, the height of the second embodiment is smaller than about 95% of the height of the first embodiment. In some other embodiments, the height of the second embodiment is smaller than about 85% of the height of the first embodiment. In some other embodiments, the height of the second embodiment is smaller than about 80% of the height of the first embodiment. In yet some other embodiments, the height of the second embodiment is smaller than about 75% of the height of the first embodiment.

The present disclosure is not limited to the embodiments described above.

It could be conceived extrusion profiles wherein the semi-minor and semi-major axes would be inverted with respect to FIG. 9 (i.e., wherein the semi-major axis would correspond substantially to a half of the height, i.e., wherein the semi-major axis would be substantially perpendicular to the upper and lower panel members). Any other shape of a cross-section of the first and second concavities could also be conceived.

Method for Assembling a Panel Structure

According to another aspect of the disclosure, there is provided a method for assembling or forming a panel structure 12, 1012.

The method according to embodiments of the present disclosure may be carried out with extrusion profiles 100, 1100 as the ones described above.

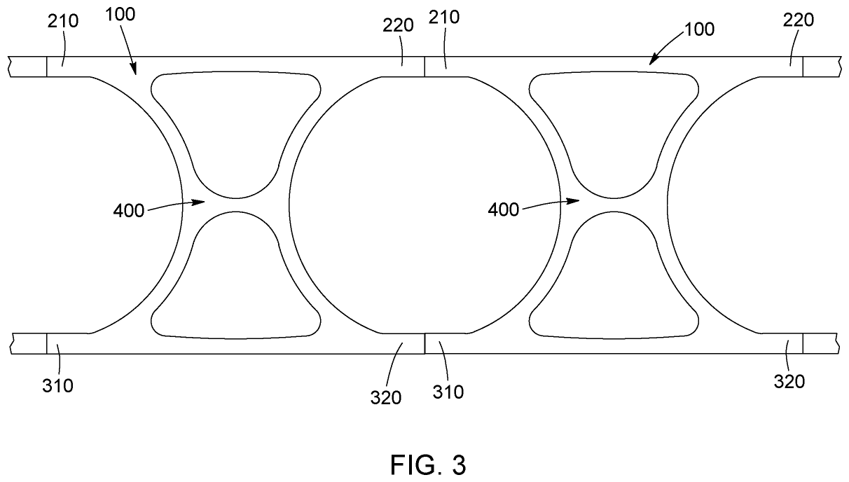

The method comprises a step of providing at least two extrusion profiles, which could correspond to the extrusion profile 100, the extrusion profile 1100 or any other suitable embodiment. The method then comprises a step of positioning a first extrusion profile and a second extrusion profile in an adjacent configuration so that the first assembling end portions of the upper and lower panels of the first extrusion profile abut respectively the second assembling end portions of the upper and lower panels of the second extrusion profile, as represented for instance in FIG. 3. The method then comprises a step of securing together the abutting first and second assembling end portions of the first and second extrusion profiles.

In the embodiment wherein the first and second extrusion profiles are at least partially formed of a weldable material, the step of securing together the abutting first and second assembling end portions of the first and second extrusion profiles comprises friction stir welding the abutting first and second assembling—or welding—end portions. It could also be conceived a panel structure wherein at least some of the extrusion profiles thereof would be formed integral with each other, for instance via extrusion. In other words, two or more of the extrusion profiles forming at least partially the panel structure could be extruded together, to reduce the number of connections needed to form the panel structure.

The extrusion profiles can be welded to each other by MIG welding (Metal inert gas; also known as Gas metal arc welding (GMAW)), TIG welding (Tungsten inert gas; also known as Gas Tungsten Arc Welding (GTAW)), Laser or FSW (friction stir welding).

In the embodiment shown, the extrusion profiles are shaped and dimensioned, in particular due to the welding clearances, so that the welding of the first and second extrusion profiles might comprise friction stir welding the abutting first and second welding end portions of the first and second extrusion profiles.

FSW can be realised with a support arranged below the portions to be welded together or with a bobbin tool (bobbin tool friction stir welding—BTFSW). BTFSW ensures full penetration in the welds and does not involve any vertical forces upon welding of adjacent profiles, thus eliminating the need for a built-in support which would reduce greatly the fatigue performances and the ultimate limit states. Moreover, BTFWS allows similar weld joints at the four welding end portions of the extrusion profile. Moreover, weld joints made by BTFSW are known to be more resistant and mechanically stronger than welding joints made by other welding techniques, for instance traditional FSW or MIG.

It is thus possible to weld together adjacent extrusion profiles with abutted welding—or butt joint or assembling—portions at the four end edges thereof (i.e., welding adjacent extrusion profiles edge to edge without using temporary welding-backing members and/or without forming welding-shoulders in the profiles to support a corresponding profile during the welding process, the providing of such shoulders which are required for some welding technologies forms irregularities in a structure of the profiles which might provide a local rigidity, form a constraint concentration and impact the constraint distribution in the profile thus reducing the fatigue life of the panel structure and of the modular structural assembly).

It is understood that contrary to the disclosed embodiments, profiles in which welding-shoulders are formed do not comprise first and second planes of symmetry P1, P2, as described above.

In other words, by avoiding the providing of such welding-shoulders, the extrusion profiles have an improved fatigue life and are shaped and dimensioned to allow welding together abutting welding end portions of adjacent extrusion profiles, for instance by BTFSW, for instance along substantially an entirety of a length of the welded extrusion profiles. In yet other words, the extrusion profiles are shaped and dimensioned to allow the first and second assembling end portions of the upper and lower panel members of adjacent hollow-shaped extrusion profiles to be abutted against each other and welded to each other along substantially the entirety of the length of the adjacent hollow-shaped extrusion profiles. Such abutted welding portions (or butt-joint welding portions) are acknowledged as being a weld with high fatigue strength.

It is understood that the extrusion profiles in accordance with the present disclosure are shaped and dimensioned to be welded symmetrically on each side of the above-mentioned first and second planes of symmetry P1, P2. In other words, the butt-joint welding portions formed between the upper and lower panel members of adjacent hollow-shaped extrusion profiles have substantially similar features and properties.

The above-described extrusion profiles, in particular due to their first and second concavities and the absence of the above-mentioned welding-shoulders, are shaped and dimensioned to allow a soft and progressive path of the different stresses undergone by the extrusion profile, for instance when assembled with similar extrusions profiles to form a panel structure of a modular structural assembly.

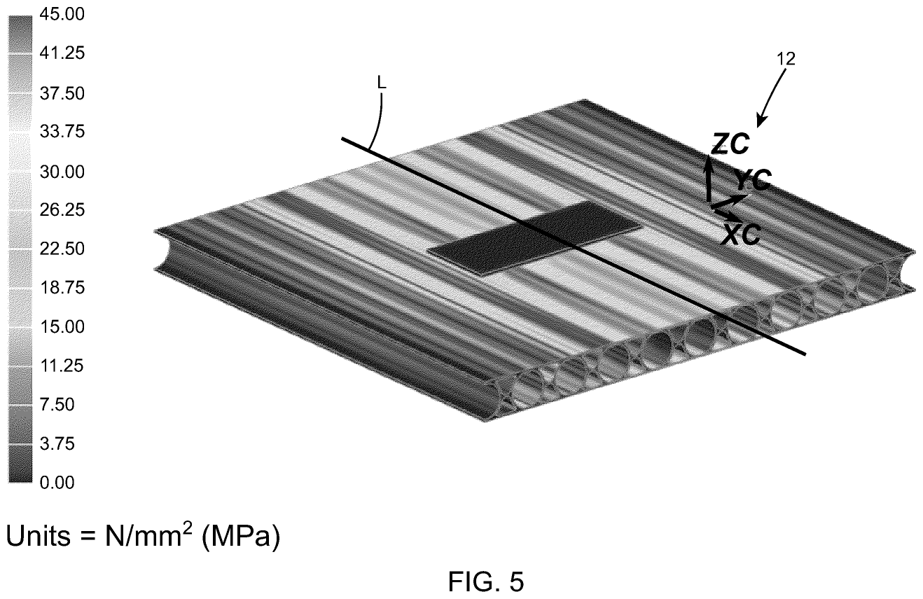

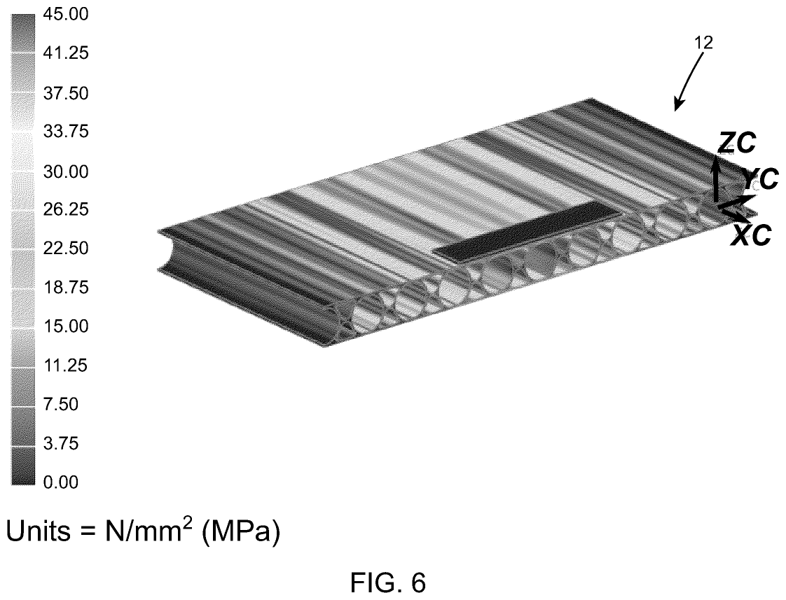

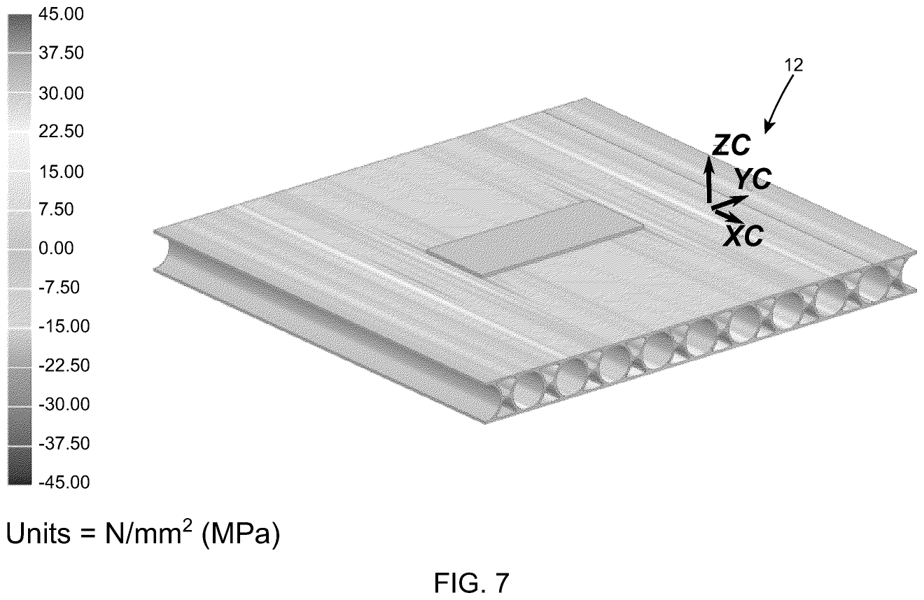

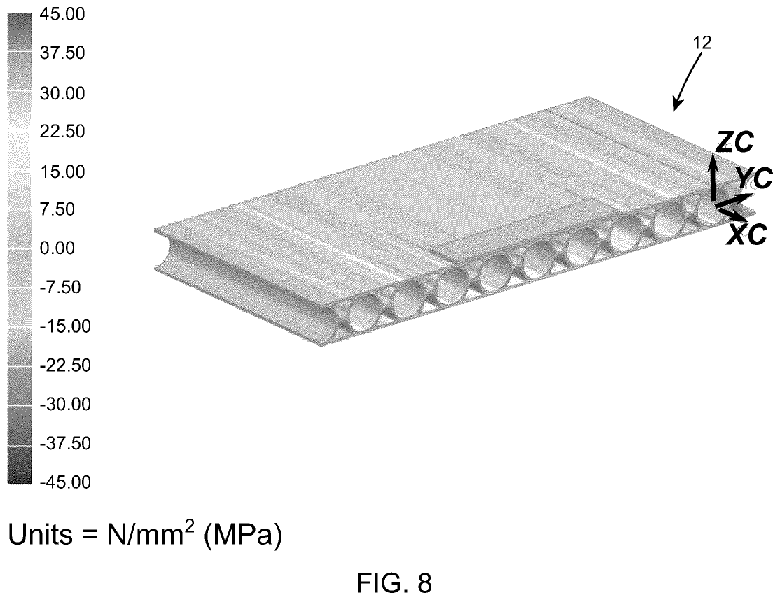

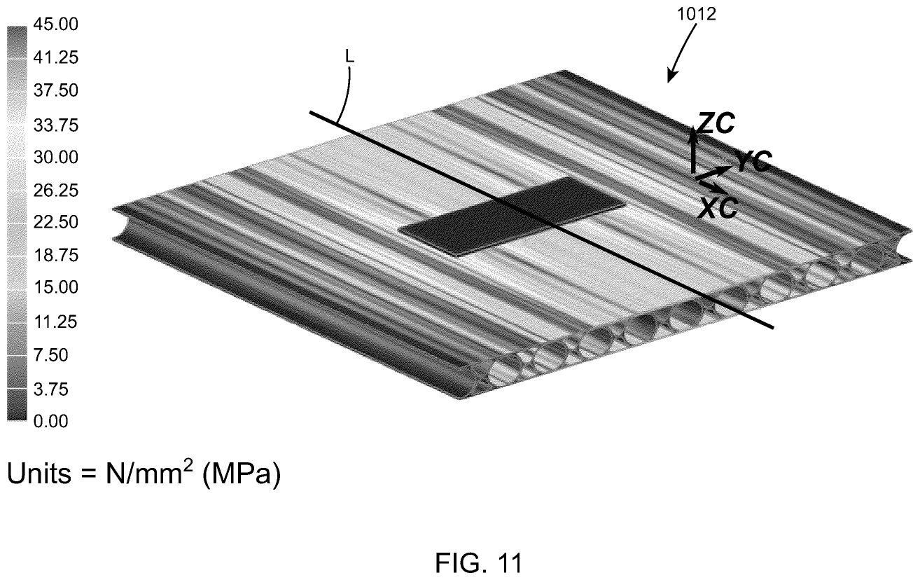

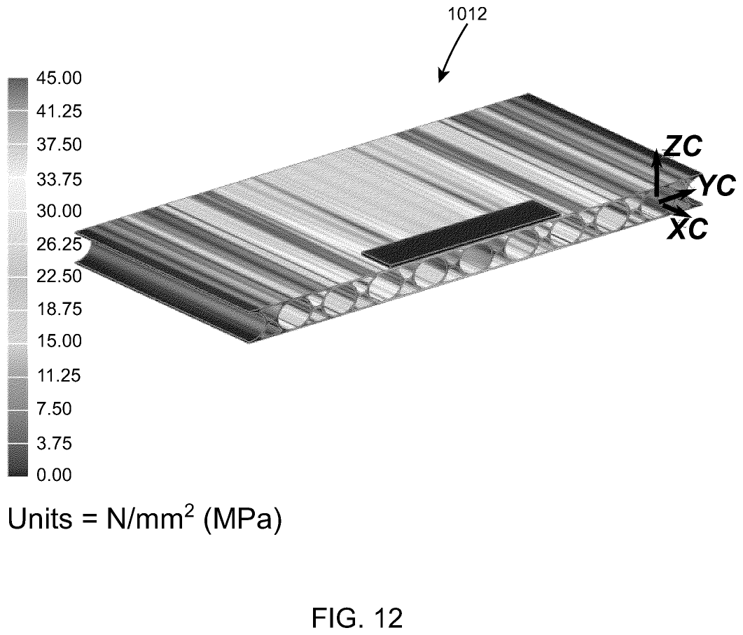

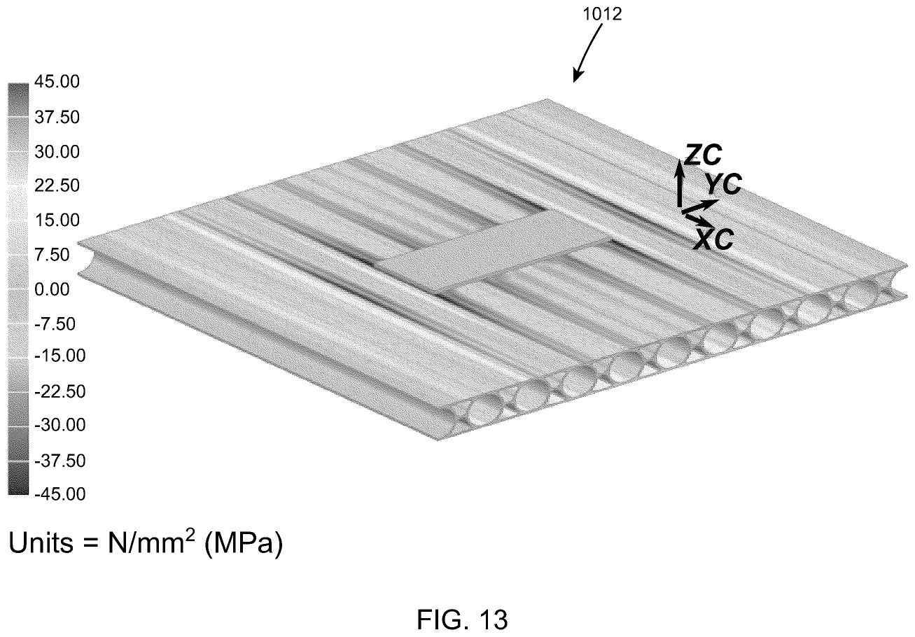

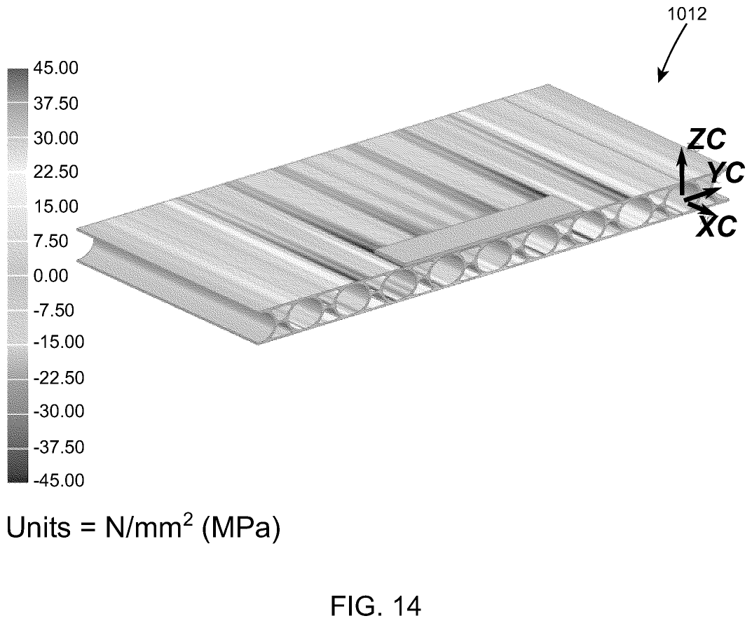

Such arrangement and intensities of stresses undergone by a panel structure 12, 1012 comprising a plurality of extrusion profiles extending side by side and assembled together (i.e., secured together or connected together for instance welded together) are represented in FIGS. 5 to 8 and FIGS. 11 to 14. In particular, FIGS. 5 and 11 are graphical representations of von Mises stresses undergone by the panel structure comprising the hollow-shaped extrusion profiles respectively in accordance with the first and second embodiments; FIGS. 6 and 12 are cross-section views of the graphical representations of FIGS. 5 and 11, better representing the von Mises stresses undergone within the extrusions profiles; FIGS. 7 and 13 are graphical representations of stresses undergone by the panel structure comprising the hollow-shaped extrusion profiles respectively in accordance with the first and second embodiments in a direction perpendicular to assembling joints formed between adjacent extrusion profiles; and FIGS. 8 and 14 are cross-section views of the graphical representations of FIGS. 7 and 13, better representing the stresses undergone within the extrusions profiles in a direction perpendicular to assembling joints formed between adjacent extrusion profiles.

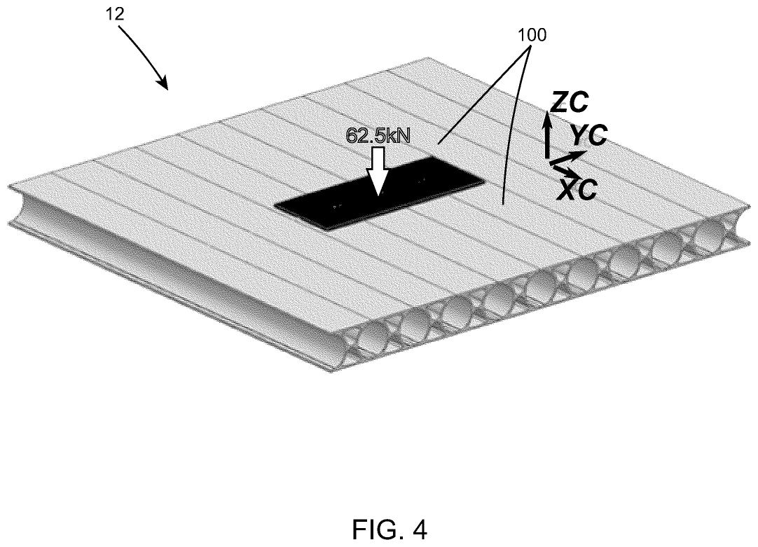

In particular, FIGS. 5 to 8 represent the stresses undergone by a panel structure 12 formed of a plurality of extrusion profiles 100 in accordance with the first embodiment; a force of 62.5 kN is applied substantially centrally via a substantially rectangular element having dimensions of 600 mm×250 mm on the panel structure simply supported in a direction substantially parallel to a longitudinal direction of the adjacent hollow-shaped extrusion profiles, for instance on lower edges of the panel structure (FIG. 4). As represented in FIGS. 5 and 6, the von Mises stresses undergone by the panel structure are smaller than about 30 MPa. As represented in FIGS. 7 and 8, the stresses undergone by the extrusion profiles of the panel structure in a direction perpendicular to the assembling joints formed between the adjacent extrusion profiles are mainly comprised between about 22.5 MPa and about—15 MPa.

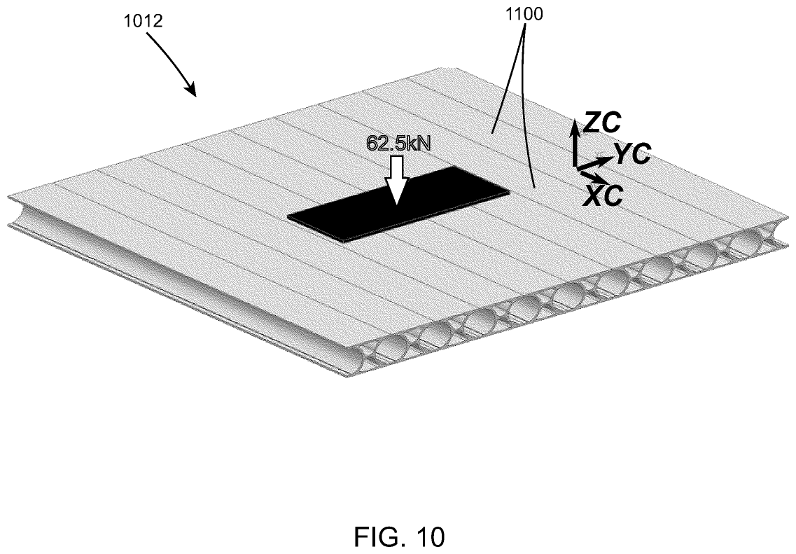

FIGS. 11 to 14 represent the stresses undergone by a panel structure 1012 formed of a plurality of extrusion profiles 1100 in accordance with the second embodiment; a force of 62.5 kN is applied substantially centrally via a substantially rectangular element having dimensions of 600 mm×250 mm on the panel structure simply supported in a direction substantially parallel to a longitudinal direction of the adjacent hollow-shaped extrusion profiles, for instance on lower edges of the panel structure (FIG. 10). As represented in FIGS. 11 and 12, the von Mises stresses undergone by the panel structure are smaller than about 35 MPa. As represented in FIGS. 13 and 14, the stresses undergone by the extrusion profiles of the panel structure in a direction perpendicular to the assembling joints formed between the adjacent extrusion profiles are mainly comprised between about 30 MPa and about—30 MPa.

Moreover, as mentioned above, the extrusion profiles 100, 1100, in particular due to the first and second upper and lower welding clearances, allow the use of BTFSW to weld together welding end portions of adjacent extrusion profiles.

Even though the extrusion profiles allow the use of BTFSW, adjacent extrusion profiles could also be welded together by MIG, which would result in a better stress resistance of the panel structure compared to panel structures formed by prior art extrusion profiles welded together.

It is understood that the shape of the extrusion profiles can easily be adjusted proportionally (i.e., without modifying a height/width ratio), in order to be adapted to different types of panel structures.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1.-47. (canceled)

48. An extrusion profile connectable to a similar extrusion profile, the extrusion profile extending along a longitudinal axis and comprising:
upper and lower panel members extending longitudinally and substantially parallel to one another in a spaced-apart relationship along a height of the extrusion profile; and
an inner core extending longitudinally between the upper and lower panel members, the inner core being integral with and connecting the upper and lower panel members, the inner core comprising first and second curved connecting members, each one having a concave side and the concave sides defining first and second concavities opened outwardly, each of the first and second curved connecting members merging smoothly with each of the upper and lower panel members in upper and lower panel-connecting portions of the inner core, the upper and lower panel-connecting portions being offset inwardly with respect to the upper and lower panel members to define assembling clearances in marginal edge regions of the upper and lower panel members.

49. The extrusion profile according to claim 48, wherein each of said first and second curved connecting members comprises a convex side opposed to the corresponding concave side, the convex sides of the first and second curved connecting members facing each other.

50. The extrusion profile according to claim 48, wherein each one of the upper and lower panel members comprises an inner face and first and second longitudinal assembling end portions, spaced-apart from one another transversally and at least partially delimiting a respective one of the assembling clearances, wherein at least a portion of the inner face of at least one of the upper and lower panel members at least partially delimiting a corresponding one of the assembling clearances is substantially flat.

51. The extrusion profile according to claim 48, wherein the inner core comprises an inner core body between the upper and lower panel-connecting portions and integral therewith, the inner core being substantially hollow and comprising an inner bridge portion extending between the first and second curved connecting members.

52. The extrusion profile according to claim 51, wherein the inner core further comprises one or more additional curved members extending longitudinally between said first and second curved connecting members.

53. The extrusion profile according to claim 48, wherein each of the upper and lower panel members has a substantially planar outer face, the outer faces of the upper and lower panel members being substantially parallel to each other.

54. The extrusion profile according to claim 48, wherein at least one of the first and second concavities has a substantially semi-circular cross-section, a radius of said at least one of the first and second concavities corresponding substantially to or being smaller than a half of the height.

55. The extrusion profile according to claim 48, wherein at least one of the first and second concavities has a substantially semi-elliptic cross-section.

56. The extrusion profile according to claim 48, wherein the extrusion profile is at least partially made of an aluminum alloy.

57. The extrusion profile according to claim 48, having a first plane of symmetry substantially perpendicular to the upper and lower panel members and substantially parallel to the longitudinal axis, and a second plane of symmetry substantially parallel to the upper and lower panel members and substantially parallel to the longitudinal axis.

58. An extrusion profile securable to a similar extrusion profile, the extrusion profile extending along a longitudinal axis and comprising:
upper and lower panel members, each comprising an inner face and first and second longitudinal assembling end portions with the inner faces of the upper and lower panel members facing each other and being spaced-apart along a height of the extrusion profile;
an inner core extending longitudinally between the inner faces of the upper and lower panel members and being integral therewith, the inner core comprising upper and lower panel-connecting portions connecting respectively with the inner faces of the upper and lower panel members;
wherein the inner core and the first and second longitudinal assembling end portions of the upper and lower panel members define at least partially first and second concavities opened outwardly;
wherein the upper panel-connecting portion is transversally offset inwardly with respect to the first and second longitudinal assembling end portions of the upper panel member to define therewith first and second upper assembling clearances; and
wherein the lower panel-connecting portion is transversally offset inwardly with respect to the first and second longitudinal assembling end portions of the lower panel member to define therewith first and second lower assembling clearances.

59. The extrusion profile according to claim 58, wherein the inner core comprises first and second curved connecting members, each one having a concave side and the concave sides at least partially delimiting the first and second concavities, the first and second curved connecting members merging smoothly with the inner faces of the upper and lower panel members in the upper and lower panel-connecting portions.

60. The extrusion profile according to claim 59, wherein the inner core comprises an inner bridge portion extending between the first and second curved connecting members, wherein the inner bridge portion comprises an extrusion center of the extrusion profile.

61. The extrusion profile according to claim 58, wherein the extrusion profile has a width defined between outer edges of the first and second longitudinal assembling end portions of one of the upper and lower panel members, the width being equal to or greater than the height of the extrusion profile.

62. The extrusion profile according to claim 58, wherein the extrusion profile is at least partially made of an aluminum alloy.

63. A modular structural assembly, comprising at least one panel structure being at least partially formed by securing together a plurality of extrusion profiles according to claim 58.

64. The modular structural assembly according to claim 63, wherein the first and second longitudinal assembling end portions of the upper and lower panel members of adjacent extrusion profiles are abutted against each other and secured to each other along substantially an entirety of a length of said adjacent extrusion profiles.

65. The modular structural assembly according to claim 64, wherein the plurality of extrusion profiles are at least partially made of a weldable material, the first and second longitudinal assembling end portions of the upper and lower panel members of the adjacent extrusion profiles being welded to each other along substantially the entirety of the length of said adjacent extrusion profiles, and wherein the first and second longitudinal assembling end portions of the upper and lower panel members of the adjacent extrusion profiles are welded to each other by friction stir welding.

66. A method for forming at least partially a modular panel structure, the method comprising:
providing first and second extrusion profiles according to claim 58;
positioning the first and second extrusion profiles in an adjacent configuration with the first longitudinal assembling end portions of the upper and lower panels of the first extrusion profile abutting respectively the second longitudinal assembling end portions of the upper and lower panels of the second extrusion profile; and
securing together the abutting first and second longitudinal assembling end portions of the first and second extrusion profiles.

67. The method according to claim 66, wherein the first and second extrusion profiles are at least partially formed of a weldable material, the securing together of the abutting first and second longitudinal assembling end portions of the first and second extrusion profiles comprising friction stir welding said abutting first and second assembling end portions, wherein the securing together of the abutting first and second longitudinal assembling end portions of the first and second extrusion profiles comprising bobbin tool friction stir welding said abutting first and second assembling end portions.
